(19) United States
(12) Patent Application Publication
(10) Pub. No.: US 2020/0183756 A1
(43) Pub. Date: Jun. 11, 2020

(54) DISTRIBUTED PROCESSING SYSTEM

(71) Applicant: NEC Corporation, Minato-ku, Tokyo (JP)

(72) Inventors: Jun SUZUKI, Tokyo (JP); Masaki KAN, Tokyo (JP); Yuki HAYASHI, Tokyo (JP)

(73) Assignee: NEC Corporation, Minato-ku, Tokyo (JP)

(21) Appl. No.: 16/339,792

(22) PCT Filed: Oct. 17, 2017
(86) PCT No.: PCT/JP2017/037460

§ 371 Date: Apr. 5, 2019

(30) Foreign Application Priority Data
Oct. 19, 2016 (JP) 2016-204770

(51) Int. Cl. G06F 9/50; G06F 16/25; H04L 29/08

(52) U.S. Cl. CPC G06F 9/5083; G06F 16/258; H04L 67/2823; H04L 67/2804; G06F 9/5061

(57) ABSTRACT

The present invention addresses a problem in which distributed processing of data of various formats could not be performed. The distributed processing system 200 according to the present invention is provided with: an interface means 201 for receiving data formats of data to be processed in a distributed manner and parameters which are dependent on the data formats of the data to be processed in the distributed manner; and a divided data generation means 202 for generating, from the data, data partitions which are processing units used when processing the data in a distributed manner, and for generating metadata corresponding to the respective data partitions, including information based on parameters which are dependent on the data formats of the source data from which the data partitions are generated.

### TECHNICAL FIELD

The present invention relates to a distributed processing system, a distributed processing method, and a program recording medium, and more particularly, to a distributed processing system, a distributed processing method, and a program recording medium which divide data and perform distributed processing.

### BACKGROUND ART

A distributed processing system as illustrated in FIG. 1 is known as a system for processing data in a distributed manner. The distributed processing system illustrated in FIG. 1 includes slave computers 321 to 323 for performing the distributed processing on data and master computer 310 for controlling the slave computers. Note that the number of slave computers is only required to be plural and is not limited to three.

The distributed processing system having such a configuration is operated as described below. Slave computers 321 to 323 divide one piece of data and hold the divided data. The divided data are referred to as data partitions. Master computer 310 generates procedures as tasks, each of which is performed on the data partition held in each of slave computers 321 to 323, and instructs each of the slave computers to perform the task. Each of slave computers 321 to 323 performs the instructed task on the held data partition. In this manner, desired processing is performed on all the data partitions.

In PTL 1, a system that divides image data and performs distributed processing is disclosed. The distributed processing system performs distributed image processing by sending divided image data and parameters (a procedure and an identification tag) associated with the image data to work stations for performing the distributed processing.

### CITATION LIST

### Patent Literature

[PTL 1] Japanese Unexamined Patent Application Publication No. H8-16766

[PTL 2] Japanese Unexamined Patent Application Publication No. 2000-020327

### SUMMARY OF INVENTION

### Technical Problem

Methods of performing processing on data partitions in distributed processing differs depending on data formats of data subjected to the distributed processing. Further, the above-mentioned distributed processing systems do not concern the data formats of the data subjected to the distributed processing. Thus, there arises a problem that the distributed processing cannot be performed on various data formats and lacks versatility.

Therefore, an object of the present invention is to solve the above-mentioned problem that distributed processing cannot be performed on various data formats and lacks versatility.

### Solution to Problem

A distributed processing system according to one aspect of the present invention, is configured to include an interface means for receiving a data format of data subjected to distributed processing and a parameter depending on the data format of the data subjected to the distributed processing, and a divided data generation means for generating, from the data, data partitions being processing units used when performing the distributed processing on the data, and generating meta data including information based on the parameter that is associated with each of the data partitions and depends on the data format of the original data from which the data partition is generated.

A program recording medium according to another aspect of the present invention, is configured to record a program causing an information processing device to realize an interface means for receiving a data format of data subjected to distributed processing and a parameter depending on the data format of the data subjected to the distributed processing, and a divided data generation means for generating, from the data, data partitions being processing units used when performing the distributed processing on the data, and generating meta data including information based on the parameter that is associated with each of the data partitions and depends on the data format of the original data from which the data partition is generated.

A distributed processing method according to another aspect of the present invention, is configured to include, by an information processing device, receiving a data format of data subjected to distributed processing and a parameter depending on the data format of the data subjected to the distributed processing, generating, from the data, data partitions being processing units used when performing the distributed processing on the data, and generating meta data including information based on the parameter that is associated with each of the data partitions and depends on the data format of the original data from which the data partition is generated.

### Advantageous Effects of Invention

According to the present invention having the above-mentioned configuration, distributed processing depending on a data format of data subjected to the distributed processing can be performed, and versatility can be improved.

### BRIEF DESCRIPTION OF DRAWINGS

FIG. 1 is a block diagram for illustrating a distributed processing system that relates to the present invention.

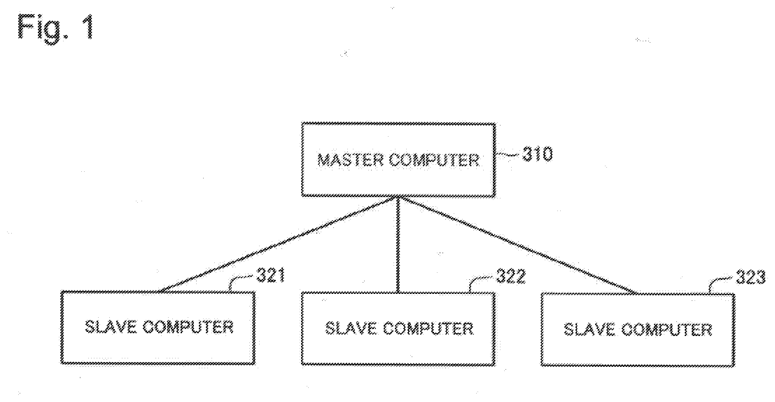

FIG. 2 is a block diagram for illustrating a configuration of a distributed processing system according to a first example embodiment of the present invention.

FIG. 3 is a diagram for illustrating an example of information used in the distributed processing system disclosed in FIG. 1.

FIG. 4 is a diagram for illustrating an example of information used in the distributed processing system disclosed in FIG. 1.

FIG. 5A is a diagram for illustrating an example of information used in the distributed processing system disclosed in FIG. 1.

FIG. 5B is a diagram for illustrating an example of information used in the distributed processing system disclosed in FIG. 1.

FIG. 6 is a diagram for illustrating an example of information used in the distributed processing system disclosed in FIG. 1.

FIG. 7 is a flowchart for showing an operation of the distributed processing system disclosed in FIG. 1.

FIG. 8 is a block diagram for illustrating a configuration of a distributed processing system according to a second example embodiment of the present invention.

FIG. 9 is a diagram for illustrating an example of a hardware configuration that realizes devices forming the distributed processing system illustrated in each of the example embodiments.

### EXAMPLE EMBODIMENT

### First Example Embodiment

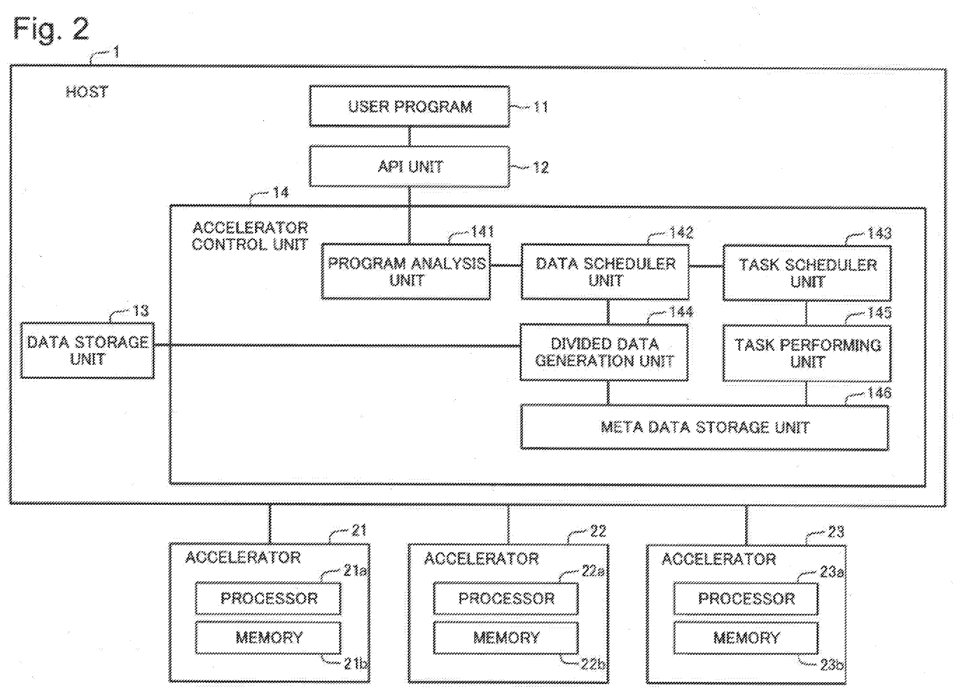

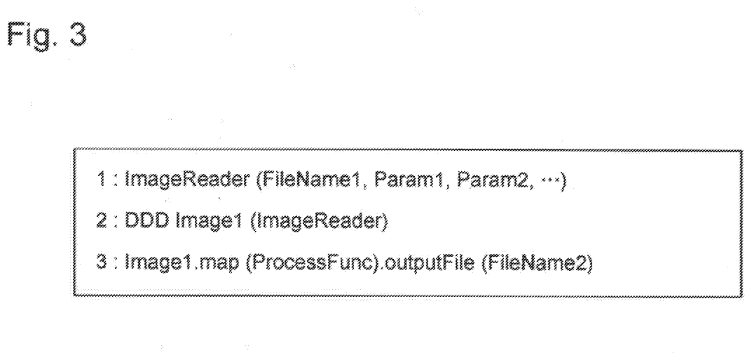

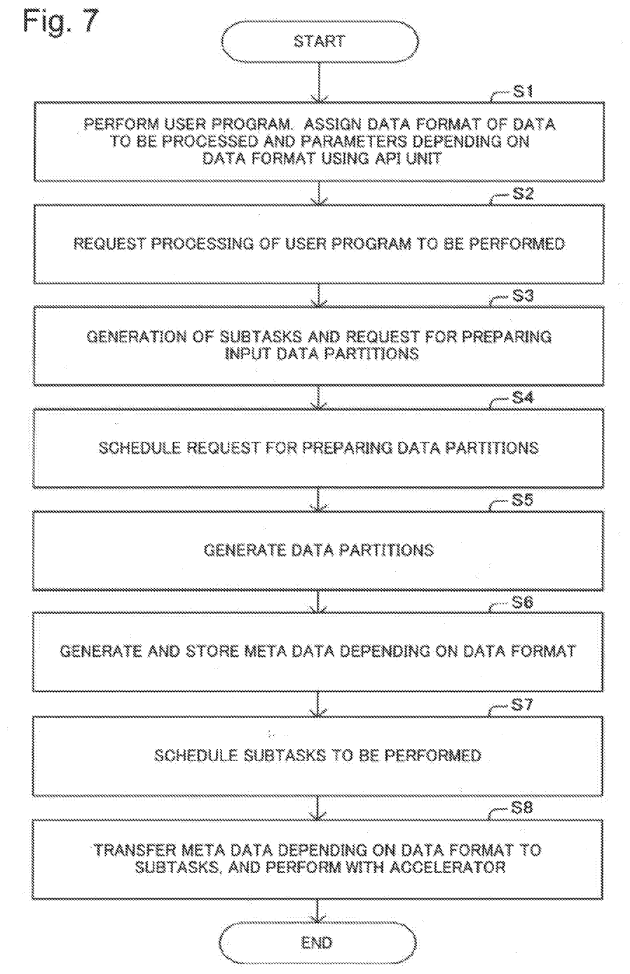

With reference to FIG. 2 to FIG. 7, a first example embodiment of the present invention is described. FIG. 2 is a block diagram for illustrating a configuration of a distributed processing system according to the first example embodiment. Each of FIG. 3 to FIG. 6 is an explanatory diagram for illustrating contents of processing performed by the distributed processing system. FIG. 7 is a flowchart for showing a distributed processing method.

### [Configuration]

As illustrated in FIG. 2, the distributed processing system according to this example embodiment includes accelerators 21 to 23 for dividing data to perform distributed processing and host 1 for controlling the processing that accelerators 21 to 23 are caused to perform. Note that the number of accelerators is not limited to three, and may be any number as long as the number is plural. Further, this example embodiment can be adopted to the case where the number of accelerators is one. In the following description, “accelerator 2” refers to any of accelerators 21 to 23, which performs loading of data or execution of processing. Further, “plurality of accelerators 2” refer to whole of accelerators 21 to 23.

As illustrated in FIG. 2, accelerator 21 is formed of a pair including processor 21a, which is equipped with a single or a plurality of arithmetic operation cores and performs processing on data partitions, and memory 21b to be used for an arithmetic operation of the processor. The other accelerators 22 and 23 have similar configurations. In general, the accelerator is equipped with more arithmetic operation cores than a CPU in a computer, and hence, is known to provide higher computing performance than the CPU. Accelerators 21 to 23 are graphics processing units (GPU) supplied by NVIDIA Corporation, for example.

In this example embodiment, data obtained by dividing a distributed processing target are referred to as “data partitions”. The distributed processing dealt in this example embodiment is realized in such a way that the processing on a data partition is regarded as a unit and is performed by the plurality of accelerators in a distributed manner.

Host 1 is an information processing device including an arithmetic operation device and a memory device. Further, as illustrated in FIG. 2, host 1 includes: user program 11 being an application program for performing the distributed processing by using the plurality of accelerators 2; application programming interface (API) unit 12 for providing an interface enabling user program 11 to use the plurality of accelerators 2; data storage unit 13 for storing data subjected to the distributed processing by the plurality of accelerators 2; and accelerator control unit 14 for controlling the distributed processing performed by the plurality of accelerators 2. The arithmetic operation device performs programs, thereby constructing user program 11, API unit 12, and accelerator control unit 14. Data storage unit 13 is configured in the memory device.

As illustrated in FIG. 2, accelerator control unit 14 further includes program analysis unit 141 for analyzing the distributed processing that user program 11 requests the plurality of accelerators 2 to perform, and data scheduler unit 142 for instructing accelerator 2 to prepare data partitions. Accelerator control unit 14 further includes: divided data generation unit 144 for reading, from data storage unit 13, a part that is associated with data partitions of the data subjected to the processing, and generating the data partitions to be loaded on a memory held in accelerator 2; and task scheduler unit 143 for instructing accelerator 2 to perform the processing on the data partitions. Accelerator control unit 14 further includes: task performing unit 145 for controlling accelerator 2 and performing the processing on the data partitions; and meta data storage unit 146 for holding meta data of the data partitions.

Now, the configuration of the above-mentioned host 1 is further described in detail.

API unit 12 (interface unit) provides user program 11 with an application program interface for creating a program that causes the plurality of accelerators 2 to perform the distributed processing. API unit 12 requests accelerator control unit 14 to perform user program 11, which is created with use of the interface provided to user program 11 by API unit 12.

In FIG. 3, there is given an example of a pseudo code of user program 11, which is created with use of the interface provided by API unit 12. When a data format of the data subjected to the distributed processing is an “image”, “ImageReader” in the first line is an object for reading the data. The “ImageReader” includes “FileName1” being a name of a file in which the image subjected to the distributed processing is stored, and “Param1” and “Param2” being parameters required for reading the data. Those parameters may be three or more. In the second line, in order that “ImageReader” deals with the data to be read on the program, the data object “DDD” is named as “Image1” and is instantiated. In the third line, “map” processing is performed on the instantiated “Image1”, and the output data undergone the map processing is stored in the file.

Specifically, the map processing is an interface for performing the same processing on each of the data elements included in the data. In this case, the processing specified by “ProcessFunc” is applied to each of the elements of the image. “ProcessFunc” is a user-defined function provided by user program 11, and is specific processing applied to each of the elements of the image. Note that user program 11 is provided randomly from the outside, and hence the user-defined function is also provided randomly from the outside. Further, the output data file is named as “FileName2”. In this program, at the point when “outputFile” is called, accelerator control unit 14 is requested to perform the processing of the accelerators specified in the first line to the third line.

As in the example of “outputFile”, API unit 12 defines an interface for triggering (starting) the request for the processing. As described above, the processing with delay in which the actual processing is performed by the plurality of accelerators 2 after the user program 11 calls the interface is referred to as delay evaluation in general. A person skilled in this field generally understands that various types of processing can be performed on the data elements included in “DDD” by defining processing other than the “map” as processing provided by the API unit 12.

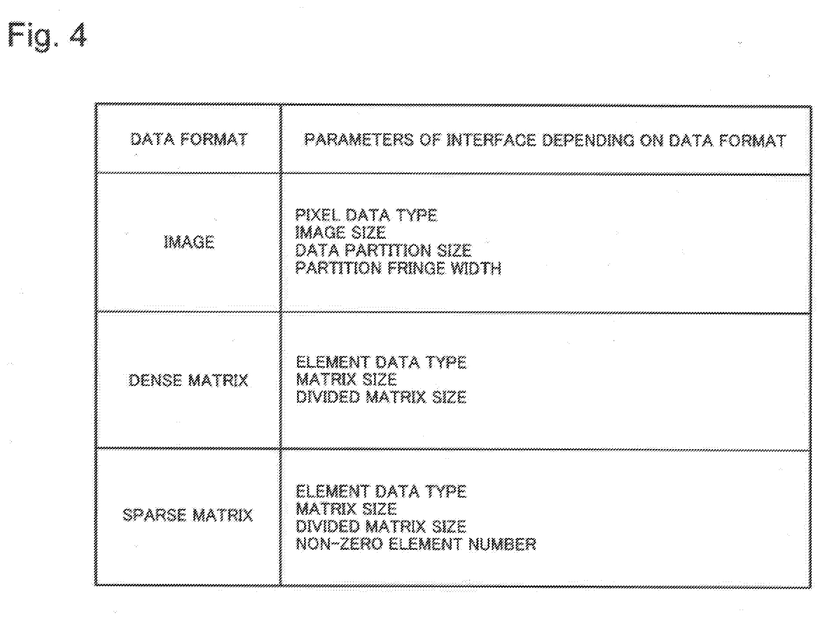

In this example embodiment, in addition to the above-mentioned “image”, various data formats such as a “dense matrix” and a “sparse matrix” can be dealt as the data formats for performing the distributed processing. In such a case, the dense matrix uses “DenseMatrixReader” in place of “ImageReader” illustrated in FIG. 3, and the sparse matrix uses “SparseMatrixReader” in place of “ImageReader”. That is to say, “Reader” depending on a data format is used. Further, parameters provided to each of “Reader” depend on a data format except for a file name. Examples of the parameters depending on the data format are given in FIG. 4.

In FIG. 4, a “pixel data type” of an image refers to a data type of each pixel. Examples of the data types include an integer type and a floating-point type. An “image size” refers to a vertical width and a horizontal width.

A unit for expressing the widths is the number of pixels. A “data partition size” refers to a vertical width and a horizontal width of a divided image included in each of the data partitions. A “partition fringe width” (redundant part size) refers to a width of a region of an image, which is held redundantly by overlapping with other partitions adjacent to each of the data partitions.

In FIG. 4, an “element data type” of the dense matrix refers to a data type of elements of the matrix. A “matrix size” refers to a vertical width and a horizontal width of the matrix. A “divided matrix size” refers to a vertical width and a horizontal width of a block included in the data partitions obtained by dividing the matrix. A unit for expressing the widths is the number of elements in the matrix. In the sparse matrix, the parameters having the same names as those for the dense matrix are the same. A “non-zero element number” refers to the number of non-zero elements included in the sparse matrix. In a similar way, in addition to the image, the dense matrix, and the sparse matrix, the interface associated with various data formats can be extended in API unit 12.

As described above, API unit 12 receives, from user program 11, a data format of the data subjected to the distributed processing and parameters depending on the data format of the data subjected to the distributed processing. Further, the parameters depending on the data format include information based on a data structure of the data such as an image size, a matrix size, and a non-zero element as described above.

Data storage unit 13 stores data being a distributed processing target before being divided. Further, data storage unit 13 is a file system, for example, and stores and manages the data with use of the memory device held in host 1.

Program analysis unit 141 receives a request for performing user program 11 from API unit 12. The processing specified in user program 11 is performed for each of the data partitions obtained by dividing the data being the processing target. The processing for the entire data, which is specified in user program 11, is referred to as a “task”, and the processing for the data partitions obtained by dividing the data is referred to as a “subtask”. The subtasks are generated from the task. Program analysis unit 141 generates the necessary number of subtasks required for the processing of the data, and requests data scheduler unit 142 to prepare the data partitions being processing targets in accelerator 2. In the example of FIG. 3, images obtained by dividing the image “Image1” are data partitions, and the subtasks for performing the processing, which is specified by the user-defined function of “ProcessFunc” for each of the pixels included in the data partitions are generated as many as the number of the data partitions.

Data scheduler unit 142 requests divided data generation unit 144 to prepare input data partitions of the subtasks that accelerator 2 is requested to perform. When preparation of the input data partitions regarding the plurality of subtasks is requested from program analysis unit 141, data scheduler unit 142 determines an optical preparation procedure.

Divided data generation unit 144 (divided data generation means) receives the request for the preparation of the input data partitions from data scheduler unit 142 to accelerator 2. At this point, the accelerator for preparing the input data partitions is also specified. Divided data generation unit 144 reads, from data storage unit 13, the data in the range associated with the input data partitions of the subtasks, and loads the data in specified accelerator 2. In this manner, the data partitions being processing units used when performing the distributed processing are generated. When reading the data, an identifier such as a file name, which is given from user program 11 to the interface of API unit 12, is used. Further, at this point, meta data regarding the loaded data partitions are generated and registered in meta data storage unit 146 (meta data storage means).

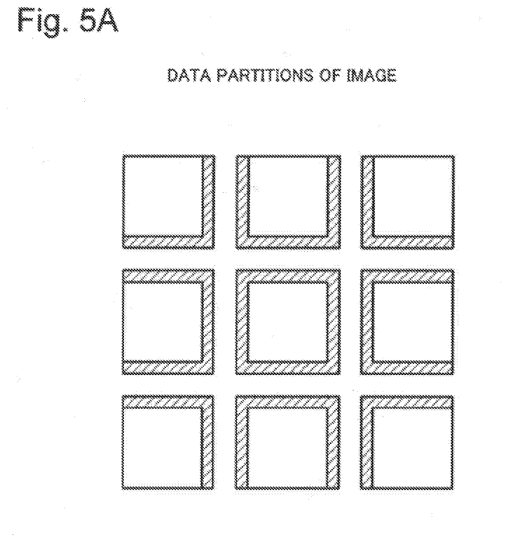

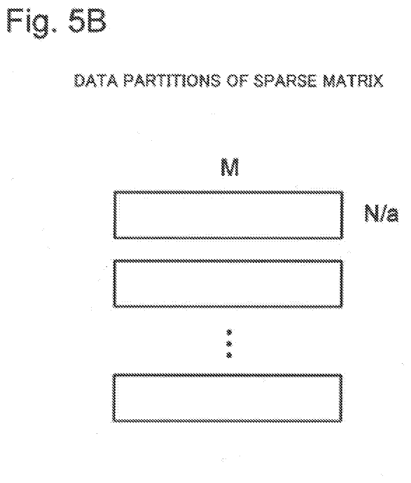

Examples of the data partitions generated by divided data generation unit 144 are illustrated in FIG. 5A and FIG. 5B. In the example of the “image” in FIG. 5A, the image is divided into 3×3. The fringes (redundant parts) for holding the pixels redundantly with the adjacent data partitions are generated. The fringe parts are indicated with the hatched lines. In the example of the “sparse matrix” in FIG. 5B, the matrix of M×N is divided into the “a” block matrix parallel to each other in a line direction. Note that these dividing methods can be expanded to a three-or-more dimensional division with respect to array data having a division number or division direction of one dimension, two dimensions, or multi dimensions. This is just the same as what generally understood by a person skilled in this field.

The meta data generated for each of the data partitions are information associated with each of the data partitions, and are information depending on data formats of the original data from which the data partitions are generated. This indicates that types of parameters included in the meta data depend on the data formats. The data formats and the information of the meta data depending on the data formats are generated from the information in FIG. 4, which is transferred from API unit 12 to user program 11, and the information of the data read from data storage unit 13.

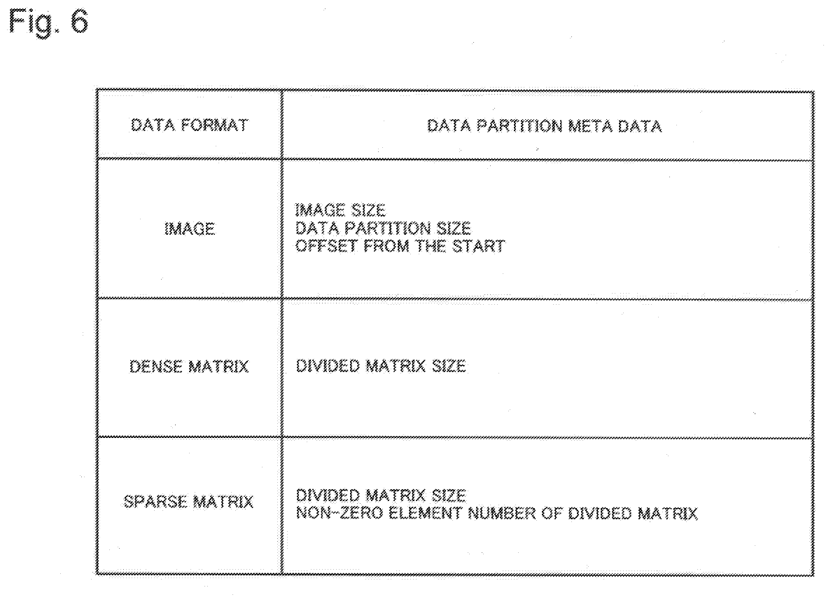

In FIG. 6, the meta data generated associated with each of the data formats are given. Note that the meta data includes the same parameters as those received by the API unit illustrated in FIG. 4 (“image size” and “data partition size”, for example). Thus, among pieces of the information of the meta data, description of the same parameters as those received by the API unit is omitted. “Offset from the start” of the data format “image” indicates a relative position with respect to the entire image of the divided images included in the data partitions. “Non-zero element number of divided matrix” of the data format “sparse matrix” indicates the non-zero element number included in the block matrix, which are obtained by dividing the sparse matrix included in the data partitions.

An example where API unit 12 illustrated in FIG. 4 uses both the information transferred from user program 11 (information received by API unit 12) and the information of the data read from data storage unit 13 at the time of generating the meta data is described with the sparse matrix. Among the parameters included in the partition meta data of the sparse matrix illustrated in FIG. 6, a “divided matrix size” can be acquired from a “divided matrix size” in the parameters of the interface provided by API unit 12 illustrated in FIG. 4. Meanwhile, with regard to the “non-zero element number of divided matrix”, the sparse matrix being the original data needs to be read from data storage unit 13. Otherwise, it is not possible to determine how many non-zero elements are actually included in the block matrix, which are obtained by dividing the original matrix included in the associated data partitions. Therefore, the “non-zero element number of divided matrix” is set based on the information of the data read from data storage unit 13.

As described above, the meta data generated by divided data generation unit 144 includes the parameters depending on the data formats of the original data before the division, from which the data partitions are generated, and the information based on the data structures of the data partitions.

Task scheduler unit 143 receives a notification of subtasks, which have completed preparation for the input data partitions, from data scheduler unit 142, and requests task performing unit 145 to perform the subtasks. In a case where a plurality of subtasks are being performed or waiting to be performed, scheduling for determining the performing order of those subtasks is performed.

Task performing unit 145 (task performing means) causes the specified accelerators to perform the subtasks specified by task scheduler unit 143. That is to say, task performing unit 145 transfers the meta data together with the data partitions to a program function for processing the data partitions. Note that the meta data is transferred from meta data storage unit 146. As an example, the case where the subtask is performed by accelerator 21 is considered. Processor 21a for performing the subtask receives a user-defined function for the subtask, addresses of the data partitions in memory 21b, which are processing targets subjected to the user-defined function, and the meta data of the data partition. Processor 21a uses the meta data and performs the user-defined function. Accordingly, the processing depending on the data format can be realized.

As an example of performing the processing depending on the data format, description is made on the processing on the image illustrated in FIG. 3. Processor 21a performs the user-defined function on the data elements included in the data partitions, the user-defined function being “ProcessFunc” transferred to the “map” in the third line in FIG. 3. In this case, the data elements are pixels included in the divided images. At this point, as an argument for “ProcessFunc”, the meta data stored in meta data storage unit 146 is transferred from task performing unit 145. “ProcessFunc” can discriminate a size of the divided images to be processed based on the data partition size included in the meta data. Further, based on the image size and the offset from the start, that is, the relative positions of the divided images with respect to the entire image, “ProcessFunc” can discriminate which parts of the peripheries of the divided images being the processing targets have the fringes. Accordingly, the processing taking the fringes into account can be performed. As an example of the processing taking the fringes into account, there is known stencil processing for equalizing pixel values of the images by using peripheral pixel values.

### [Operation]

Next, mainly with reference to a flowchart of FIG. 7, detailed description is made on an operation of this example embodiment of the present invention.

When user program 11 is performed, the interface provided by API unit 12 is used in user program 11 (Step S1). At this point, the data format of the data to be processed in the distributed manner and the parameters depending on the data format are transferred to the interface.

When a command for triggering the processing is called at the interface provided by API unit 12, accelerator control unit 14 is requested to perform the processing of user program 11, which has been commanded to API unit 12 by that time. That is to say, delay evaluation is performed on the processing of user program 11 (Step S2).

Program analysis unit 141 that receives the request to perform user program 11 generates entries of the subtasks for performing the processing of user program 11 for each of the data partitions obtained by dividing the data to be processed (Step S3). Subsequently, program analysis unit 141 requests data scheduler unit 142 to prepare the data partitions being input of the subtasks in any of accelerators 2.

Data scheduler unit 142 selects the accelerator for preparing the input data partitions, and requests divided data generation unit 144 to prepare the input data partitions (Step S4). In a case where data scheduler unit 142 receives a request to prepare input data partitions of a plurality of subtasks from program analysis unit 141, scheduling for determining an optical order for preparing the data partitions is performed.

Divided data generation unit 144 reads part of the data to be processed, which is stored in data storage unit 13, the part associated with the input data partitions of the subtasks. Then, divided data generation unit 144 loads the read part to the memory of accelerator 2 specified by data scheduler unit 142 (Step S5). Divided data generation unit 144 generates the meta data depending on the data to be processed from which the data partitions are loaded, and stores the generated meta data in meta data storage unit 146 (Step S6).

Task scheduler unit 143 receives, from data scheduler unit 142, a notification of the subtasks which have completed the preparation of the input data partitions, and requests task performing unit 145 to perform the subtasks. At this point, in a case where a plurality of subtasks that are not yet performed are present, scheduling for determining an order for performing the subtasks is performed (Step S7).

Task performing unit 145 causes accelerator 2, which have completed the preparation for the input data partitions, to perform the subtasks notified from task scheduler unit 143 (Step S8). At this point, the meta data of the input data partitions, which are stored in meta data storage unit 146, are transferred to the user-defined function for performing the subtasks. Then, the user-defined function is performed by using the transferred meta data.

As described above, this example embodiment includes API unit 12 which provides the interface receiving, from the user program, the data format of the data subjected to the distributed processing and the information depending on the data format. Further, this example embodiment includes divided data generation unit 144. Divided data generation unit 144 generates the meta data depending on the data format subjected to the distributed processing for each of the data partitions by combining the information that API unit 12 receives from the user program at the time of generating the data partitions being units for performing the distributed processing and the information acquired at the time of generating the data partitions. Further, this example embodiment includes task performing unit 145 which transfers the meta data to the user-defined function in the case where the user-defined function provided by the user program is performed for the data partitions in the accelerator. With this configuration, this example embodiment operates in such a way as to transfer the meta data to the user-defined function in the case of receiving, from the user program, the data format of the data to be processed in the distributed manner and the information depending on the data format, generating the meta data for each of the data partitions by combining the received information and the information acquired at the time of generating the data partitions, and performing the processing for the data partitions by using the user-defined function. As a result, the distributed processing depending on the data format can be realized, and the distributed processing can be performed to the various data formats.

### Second Example Embodiment

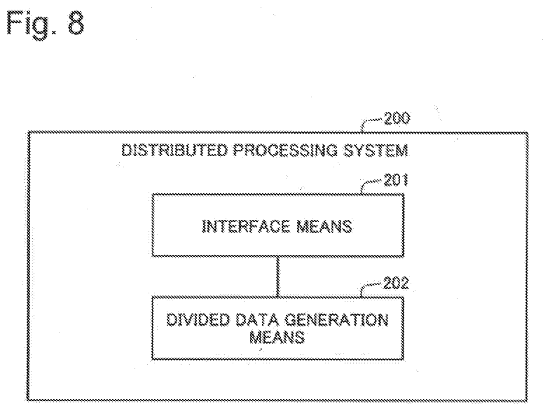

Next, with reference to FIG. 8, a second example embodiment of the present invention is described. FIG. 8 is a block diagram for illustrating a configuration of a distributed processing system according to the present invention.

As illustrated in FIG. 8, a distributed processing system 200 includes interface means 201, which is constructed by incorporating a program to an arithmetic operation device, not shown, and a divided data generation means 202. Interface means 201 receives the data format of the data subjected to the distributed processing and parameters depending on the data format of the data subjected to the distributed processing. Divided data generation means 202 generates, from the data, the data partitions being processing units used when performing the distributed processing on the data, and generates the meta data including the information based on the parameters that are associated with each of the data partitions and depend on the data format of the original data from which the data partitions are generated.

Divided data generation means 202 generates the meta data based on, for example, the information received by interface means 201 and the information acquired by reading the original data from which the data partitions are generated.

The distributed processing system having the above-mentioned configuration operates in such a way as to transfer the meta data to the user-defined function in the case of receiving, from the user program, the data format of the data subjected to the distributed processing and the information depending on the data format, generating the meta data for each of the data partitions by combining the received information and the information acquired at the time of generating the data partitions, and performing the processing for the data partitions by using the user-defined function. As a result, the distributed processing depending on the data format can be realized, and the distributed processing can be performed on the various data formats.

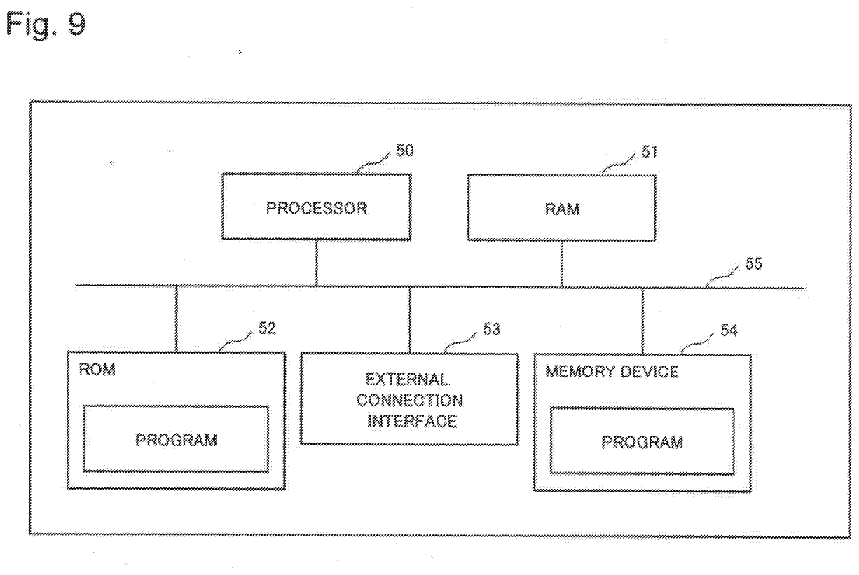

Each unit of host 1 illustrated in FIG. 2 is realized by hardware resources exemplified in FIG. 9. That is to say, the configuration illustrated in FIG. 9 includes processor 50, random access memory (RAM) 51, read only memory (ROM) 52, external connection interface 53, recording device 54, and bus 55 for connecting the respective components. User program 11 in FIG. 2 may be stored in ROM 52 or recording device 54.

In the above-mentioned example embodiments, as an example of performance by processor 50 illustrated in FIG. 9, description is made on the case where processor 50 reads out a computer program to RAM 51 to execute the computer program after the computer program capable of achieving the above-mentioned functions is provided to host 1. However, a part of or an entirety of the functions given to the respective blocks in the above drawings may be realized as hardware.

The provided computer program may be stored in a readable and writable memory (temporary storage medium) or a computer-readable memory device such as a hard disk device. Further, in such a case, it can be understood that the present invention is configured by codes indicating the computer program or a memory medium storing the computer program.

### SUPPLEMENTARY NOTE

A part of or an entirety of the example embodiments can be described as in the following supplementary notes. Now, an outline of the distributed processing system, the program recording medium, and the distributed processing method according to the present invention is described. However, the present invention is not limited to the following configurations.

### Supplementary Note 1

A distributed processing system including:

interface means for receiving a data format of data subjected to distributed processing and a parameter depending on the data format of the data subjected to the distributed processing; and

divided data generation means for generating, from the data, data partitions being processing units used when performing the distributed processing on the data, and generating meta data including information based on the parameter that is associated with each of the data partitions and depends on the data format of the original data from which the data partition is generated.

### Supplementary Note 2

The distributed processing system according to supplementary note 1, wherein

the divided data generation means generates the meta data based on information received by the interface means and information acquired by reading the original data from which the data partition is generated.

### Supplementary Note 3

The distributed processing system according to supplementary note 2, wherein

the divided data generation means generates the meta data including the parameter depending on the data format of the original data from which the data partition is generated.

### Supplementary Note 4

The distributed processing system according to supplementary note 2 or 3, wherein

the divided data generation means generates the meta data, based on a data structure of the data partition.

### Supplementary Note 5

The distributed processing system according to any one of supplementary notes 1 to 4, wherein

the parameter includes information based on a data structure of the data.

### Supplementary Note 5.1

The distributed processing system according to any one of supplementary notes 1 to 5, wherein

the data format of the data is an image, and

the parameter includes an image size of the data, an image size of the data partition to be generated, and a redundant part size of the data partition to be generated.

### Supplementary Note 5.2

The distributed processing system according to supplementary note 5.1, wherein

the meta data include an image size of the data, an image size of the data partition to be generated, and an offset of the data partition to be generated from a start of the data.

### Supplementary Note 5.3

The distributed processing system according to any one of supplementary notes 1 to 5, wherein

the data format of the data is a dense matrix, and

the parameter includes a matrix size of the data and a matrix size of the data partition to be generated.

### Supplementary Note 5.4

The distributed processing system according to supplementary note 5.3, wherein

the meta data include a matrix size of the data partition to be generated.

### Supplementary Note 5.5

The distributed processing system according to any one of supplementary notes 1 to 5, wherein

the data format of the data is a sparse matrix, and

the parameter includes a matrix size of the data, a matrix size of the data partition to be generated, and a non-zero element number in the data.

### Supplementary Note 5.6

The distributed processing system according to supplementary note 5.5, wherein

the meta data includes a matrix size of the data partition to be generated and a non-zero element number in the data partition to be generated.

### Supplementary Note 6

The distributed processing system according to any one of supplementary notes 1 to 5, further including

task performing means for transferring the meta data together with the data partition to a program function for processing the data partition.

### Supplementary Note 7

The distributed processing system according to supplementary note 6, wherein

the program function for processing the data partition is a user-defined function received from an outside.

### Supplementary Note 8

The distributed processing system according to supplementary note 6 or 7, further including

meta data storage means for storing the meta data generated by the divided data generation means and providing the task performing means with the meta data being stored, when the task performing means causes the program function for processing the data partition to be executed.

### Supplementary Note 9

A program recording medium recording a program causing an information processing device to realize:

an interface means for receiving a data format of data subjected to distributed processing and a parameter depending on the data format of the data subjected to the distributed processing; and

a divided data generation means for generating, from the data, data partitions being processing units used when performing the distributed processing on the data, and generating meta data including information based on the parameter that is associated with each of the data partitions and depends on the data format of the original data from which the data partition is generated.

### Supplementary Note 9.1

The program recording medium according to supplementary note 9, wherein

the divided data generation means generates the meta data, based on information received by the interface means and information acquired by reading the original data from which the data partition is generated.

### Supplementary Note 9.2

The program recording medium according to supplementary note 9.1, wherein

the divided data generation means generates the meta data including the parameter depending on the data format of the original data from which the data partition is generated.

### Supplementary Note 9.3

The program recording medium according to supplementary note 9.1 or 9.2, wherein

the divided data generation means generates the meta data, based on a data structure of the data partition.

### Supplementary Note 9.4

The program recording medium according to any one of supplementary notes 9 to 9.3, wherein

the parameter includes information based on a data structure of the data.

### Supplementary Note 9.5

The program recording medium according to any one of supplementary notes 9 to 9.4, further causing the information processing device to realize

task performing means for transferring the meta data together with the data partition to a program function for processing the data partition.

### Supplementary Note 9.6

The program recording medium according to supplementary note 9.5, further causing the information processing device to realize

meta data storage means for storing the meta data generated by the divided data generation means, and providing the task performing means with the meta data being stored, when the task performing means causes the program function for processing the data partition to be executed.

### Supplementary Note 10

A distributed processing method by an information processing device, the method including:

receiving a data format of data subjected to distributed processing and a parameter depending on the data format of the data subjected to the distributed processing; and

generating, from the data, data partitions being processing units used when performing the distributed processing on the data, and generating meta data including information based on the parameter that is associated with each of the data partitions and depends on the data format of the original data from which the data partition is generated.

### Supplementary Note 10.1

The distributed processing method according to supplementary note 10, further including

generating the meta data, based on received information and information acquired by reading the original data from which the data partition is generated.

### Supplementary Note 10.2

The distributed processing method according to supplementary note 10.1, further including

generating the meta data including the parameter depending on the data format of the original data from which the data partition is generated.

### Supplementary Note 10.3

The distributed processing method according to supplementary note 10.1 or 10.2, further including

generating the meta data, based on a data structure of the data partition.

### Supplementary Note 10.4

The distributed processing method according to any one of supplementary notes 10 to 10.3, wherein

the parameter includes information based on a data structure of the data.

### Supplementary Note 10.5

The distributed processing method according to any one of supplementary notes 10 to 10.4, wherein

the information processing device further transfers the meta data together with the data partition to a program function for processing the data partition.

### Supplementary Note 10.6

The distributed processing method according to supplementary note 10.5, wherein

the information processing device further stores the generated meta data, and provides task performing means with the meta data being stored, when the task performing means causes the program function for processing the data partition to be executed.

The above-mentioned program recording medium is a computer-readable recording medium. The program recording medium is a portable medium such as a flexible disk, an optical disk, a magneto-optical disk, and a semiconductor memory, for example.

As described above, the invention of the present application is described with reference to the example embodiments. However, the invention of the present application is not limited to the above-mentioned example embodiments. Various changes that can be understood by a person skilled in the art can be made to the configuration and details of the invention of the present application without departing from the invention of the present application.

This application is based upon and claims the benefit of priority from Japanese Patent Application No. 2016-204770, filed on Oct. 19, 2016, the disclosure of which is incorporated herein in its entirety by reference.

### INDUSTRIAL APPLICABILITY

The present invention is applicable to a case where distributed processing is performed for data of various data formats using an accelerator. As an application field, a computer for image processing or data analysis is conceivable.

### REFERENCE SIGNS LIST

1 Host
11 User program
12 API unit
13 Data storage unit
14 Accelerator control unit
141 Program analysis unit
142 Data scheduler unit
143 Task scheduler unit
144 Divided data generation unit
145 Task performing unit
146 Meta data storage unit
21,22,23 Accelerator
21a,22a,23a Processor
21b,22b,23b Memory
200 Distributed processing system
201 Interface unit
202 Divided data generation unit
310 Master computer
321,322,323 Slave computer

What is claimed is:

1. A distributed processing system comprising:
interface unit that receives a data format of data subjected to distributed processing and a parameter depending on the data format of the data subjected to the distributed processing; and
divided data generation unit that generates, from the data, data partitions being processing units used when performing the distributed processing on the data, and generates meta data including information based on the parameter that is associated with each of the data partitions and depends on the data format of the original data from which the data partition is generated.

2. The distributed processing system according to claim 1, wherein
the divided data generation unit generates the meta data, based on information received by the interface unit and information acquired by reading the original data from which the data partition is generated.

3. The distributed processing system according to claim 2, wherein
the divided data generation unit generates the meta data including the parameter depending on the data format of the original data from which the data partition is generated.

4. The distributed processing system according to claim 2, wherein
the divided data generation unit generates the meta data, based on a data structure of the data partition.

5. The distributed processing system according to claim 1, wherein
the parameter includes information based on a data structure of the data.

6. The distributed processing system according to claim 1, wherein
the data format of the data is an image, and
the parameter includes an image size of the data, an image size of the data partition to be generated, and a redundant part size of the data partition to be generated.

7. The distributed processing system according to claim 6, wherein
the meta data include an image size of the data, an image size of the data partition to be generated, and an offset of the data partition to be generated from a start of the data.

8. The distributed processing system according to claim 1, wherein
the data format of the data is a dense matrix, and
the parameter includes a matrix size of the data and a matrix size of the data partition to be generated.

9. The distributed processing system according to claim 8, wherein
the meta data include a matrix size of the data partition to be generated.

10. The distributed processing system according to claim 1, wherein
the data format of the data is a sparse matrix, and
the parameter includes a matrix size of the data, a matrix size of the data partition to be generated, and a non-zero element number in the data.

11. The distributed processing system according to claim 10, wherein
the meta data includes a matrix size of the data partition to be generated and a non-zero element number in the data partition to be generated.

12. The distributed processing system according to claim 1, further comprising
task performing unit that transfers the meta data together with the data partition to a program function for processing the data partition.

13. The distributed processing system according to claim 12, wherein
the program function for processing the data partition is a user-defined function received from an outside.

14. The distributed processing system according to claim 12, further comprising
meta data storage unit that stores the meta data generated by the divided data generation means, and provides the task performing unit with the meta data being stored, when the task performing unit causes the program function for processing the data partition to be executed.

15. A non-transitory computer-readable storage medium recording a program causing an information processing device to realize:
interface unit that receives a data format of data subjected to distributed processing and a parameter depending on the data format of the data subjected to the distributed processing; and
divided data generation unit that generates, from the data, data partitions being processing units used when performing the distributed processing on the data, and generates meta data including information based on the parameter that is associated with each of the data partitions and depends on the data format of the original data from which the data partition is generated.

16. The non-transitory computer-readable storage medium according to claim 15, wherein
the divided data generation unit generates the meta data, based on information received by the interface unit and information acquired by reading the original data from which the data partition is generated.

17. The non-transitory computer-readable storage medium according to claim 16, wherein
the divided data generation unit generates the meta data including the parameter depending on the data format of the original data from which the data partition is generated.

18.-21. (canceled)

22. A distributed processing method by an information processing device, the method comprising:
receiving a data format of data subjected to distributed processing and a parameter depending on the data format of the data subjected to the distributed processing; and
generating, from the data, data partitions being processing units used when performing the distributed processing on the data, and generating meta data including information based on the parameter that is associated with each of the data partitions and depends on the data format of the original data from which the data partition is generated.

23. The distributed processing method according to claim 22, further comprising
generating the meta data, based on received information and information acquired by reading the original data from which the data partition is generated.

24. The distributed processing method according to claim 23, further comprising
generating the meta data including the parameter depending on the data format of the original data from which the data partition is generated.

25.-28. (canceled)
